(19) United States
(12) Patent Application Publication
(10) Pub. No.: US 2013/0159257 A1
(43) Pub. Date: Jun. 20, 2013

(54) Systems, Method, and Computer Program Products Providing Sparse Snapshots

(71) Applicants: Anureita Rao, San Francisco, CA (US); Ananthan Subramanian, Menlo Park, CA (US)

(72) Inventors: Anureita Rao, San Francisco, CA (US); Ananthan Subramanian, Menlo Park, CA (US)

(73) Assignee: NETAPP, INC., Sunnyvale, CA (US)

(21) Appl. No.: 13/331,978

(22) Filed: Dec. 20, 2011

(51) Int. Cl. G06F 17/30

(52) U.S. Cl. 707/649; 707/640; 707/E17.01

(57) ABSTRACT

A method performed in a computer-based storage system includes creating a copy of an active file system at a first point in time, where the active file system includes user data, metadata describing a structure of the active file system and the user data, and a first data structure describing storage locations of the user data and the metadata, in which creating a copy of the active file system includes selectively omitting a portion of the user data and a portion of the metadata from the copy.

### TECHNICAL FIELD

The present description relates, generally, to computer data storage systems and, more specifically, to techniques for providing snapshots in computer data storage systems.

### BACKGROUND

In a computer data storage system which provides data storage and retrieval services, an example of a copy-on-write file system is a Write Anywhere File Layout (WAFL™) file system available from NetApp, Inc. The data storage system may implement a storage operating system to functionally organize network and data access services of the system, and implement the file system to organize data being stored and retrieved. Contrasted with a write-in-place file system, a copy-on-write file system writes new data to a new block in a new location, leaving the older version of the data in place (at least for a time). In this manner, a copy-on-write file system has the concept of data versions built in, and old versions of data can be saved quite conveniently.

An additional concept in data storage systems includes data replication. One kind of data replication is data mirroring, where data is copied to another physical (destination) site and continually updated so that the destination site has an up to date copy, or nearly up to date copy, of the data as the data changes on the originating (source) system. Another concept is data backup, where old versions of the data are periodically stored. Whether data is mirrored or backed-up, the replicated data can be used to recover from a loss of data at the source. A user simply accesses the most recent data saved, rather than starting from scratch.

In some systems, snapshots are a key feature in data replication. In short, a snapshot represents the state of a file system at a particular point in time (referred to hereinafter as a consistency point). As the active file system (e.g., the file system actively responding to client requests for data access) is modified, it diverges from the most recent snapshot. At the next consistency point, the active file system is copied and becomes the most recent snapshot. Subsequent snapshots can be created indefinitely, as often as desired, which leads to more and more old snapshots being saved to the system.

Real world data storage systems are limited by available space, though some data storage systems may have more space than others. Eventually, a data storage system may begin to reach the limits of its capacity and decisions may be made about what to save subsequently and what to delete. For example, a data storage system implementing a copy-on-write system referred to as WAFL™ includes a snapshot autodelete feature to delete old snapshots as storage space runs low. However, at times an autodelete feature may delete data that is needed for a subsequent read or write operation. Thus, it may be better in some instances to create smaller snapshots, thereby saving storage space, rather than relying on an autodelete feature.

### BRIEF DESCRIPTION OF THE DRAWINGS

The present disclosure is best understood from the following detailed description when read with the accompanying figures.

FIG. 1 is an illustration of an example network storage system in which various embodiments may be implemented.

FIG. 2 is an illustration of an example active file system and an example snapshot tool adapted according to one embodiment.

FIG. 3 is an illustration of an example data replication process adapted according to one embodiment.

FIG. 4 is an illustration of an example process for replicating data using a sparse snapshot according to one embodiment.

### SUMMARY

Various embodiments include systems, methods, and computer program products that create sparse snapshots. In one example, a method creates snapshots that omit data that is unneeded for a particular purpose. Some embodiments omit old user data that is irrelevant for a compare and send operation. Furthermore, some embodiments omit various items of metadata depending on whether a snapshot is used in a physical replication operation or in a logical replication operation. The sparse snapshots use less storage space on the system than do conventional snapshots, thereby creating storage efficiency and reducing the chance that a snapshot may be undesirably deleted due to space requirements.

One of the broader forms of the present disclosure involves a method performed in a computer-based storage system including creating a copy of an active file system at a first point in time, where the active file system includes user data, metadata describing a structure of the active file system and the user data, and a first data structure describing storage locations of the user data and the metadata, in which creating a copy of the active file system includes selectively omitting a portion of the user data and a portion of the metadata from the copy.

Another of the broader forms of the present disclosure involves a network-based storage system including a memory and at least one processor, in which the processor is configured to access instructions from the memory and perform the following operations: creating a copy of an active file system, the copy including at least a portion of metadata in the active file system and a portion of user data in the active file system, in which creating a copy of the active file system includes: omitting blocks of the metadata and blocks of the user data from the copy based on a type of the user data and a type of the metadata in the blocks, comparing the copy to a previous snapshot of the active file system to identify differences between the copy and the snapshot; and sending portions of the copy that correspond to the differences to a data destination.

Another of the broader forms of the present disclosure involves a computer program product having a computer readable medium tangibly recording computer program logic for performing data replication in a computer-based storage system, the computer program product including code to begin a snapshot creation process for an active file system at a consistency point, code to discern data types in respective data storage blocks in the active file system, code to create a first snapshot that omits portions of user data and portions of metadata responsive to discerning the data types, and code to compare the first snapshot to a second snapshot to identify new data to send to a destination.

Another of the broader forms of the present disclosure involves a method performed in a computer-based storage system, the method including creating a snapshot of an active file system at a consistency point, where the active file system includes user data, metadata describing a structure of the active file system and the user data, and a first data structure describing storage locations of the user data and the metadata, after the snapshot has been created, selectively deleting a portion of the user data and a portion of the metadata from the snapshot by marking one or more storage block as unused.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

It is understood that various embodiments may be implemented in a Network Attached Storage (NAS), a Storage Area Network (SAN), or any other network storage configuration. Further, some embodiments may be implemented using a single physical or virtual storage drive or using multiple physical or virtual storage drives (e.g., one or more Redundant Arrays of Independent Disks (RAIDs)). Various embodiments are not limited by the particular architecture of the computer-based storage system. Furthermore, the following examples refer to some items that are specific to the WAFL™ file system, and it is understood that the concepts introduced herein are not limited to the WAFL™ file system but are instead generally applicable to various copy-in-place file systems now known or later developed.

Various embodiments disclosed herein provide for snapshots that selectively omit some data and are referred to in this example as sparse snapshots. Various embodiments attempt to minimize the amount of space locked down by a snapshot that is used for data replication. In many data replication processes, a base snapshot is used only to compare against a current file system state. In such a system, there is a minimum amount of metadata used by a comparing operation to compare the base snapshot to the current file system state to discern that a particular block in the active file system should be sent to a destination as part of an incremental transfer. Additionally, in many instances, the system will not use the contents of the L0s (level 0 data, which includes old user data) of the base snapshot to make the comparison.

With the recognition that much of the data saved by a snapshot is not used by a data replication process, sparse snapshots can be a useful tool in a storage operating system that provides copy-in-place file functionality. In many instances, a sparse snapshot is similar to a conventional snapshot except that only a subset of its blocks are protected by a summary map explained below with respect to FIG. 2. A summary map may be implemented with a storage object referred to as a volume, which logically organizes data within the system and comprises the file system. This subset of protected blocks is determined by the creator of the snapshot and the purpose for which the snapshot will be used.

For example, a sparse snapshot taken to provide a backing store for a volume cloning operation might protect only the volume's buftrees (or “buffer trees”—each inode in the file system is made up of a ‘tree’ of blocks, indirects and L0s; the inode points to ‘n’ indirect blocks; each indirect block in turn points to ‘m’ indirect blocks and eventually indirect blocks point to L0 blocks; this ‘tree’ of blocks rooted at the inode is called a buftree), the volume's high-level metadata (e.g., an inode block in a WAFL™ storage system) and a few other pieces of metadata that are used to read from the snapshotted volume. The other blocks in the volume are left unprotected and available for the write allocator and front end operations to overwrite.

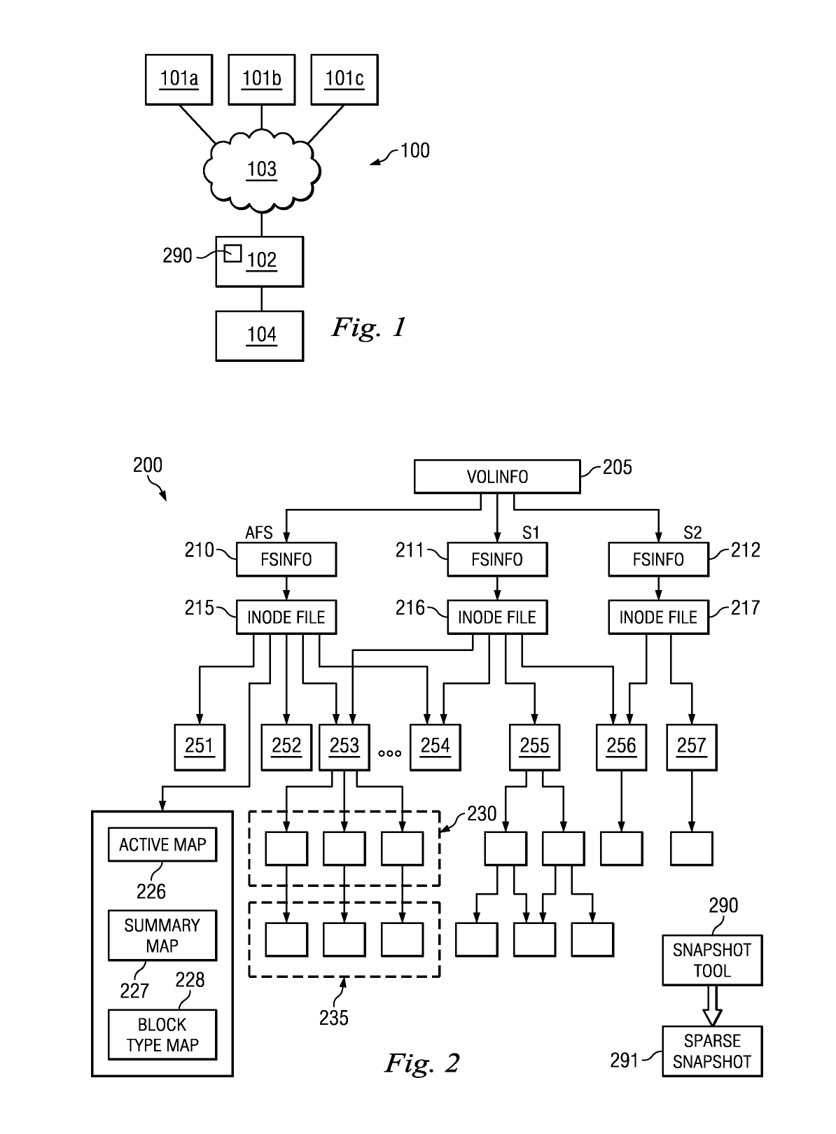

FIG. 1 is an illustration of an example network storage system 100 implementing a storage operating system (not shown) in which various embodiments may be implemented. Storage server 102 is coupled to a persistent storage subsystem 104 and to a set of clients 101 through a network 103. The network 103 may include, for example, a local area network (LAN), wide area network (WAN), the Internet, a Fibre Channel fabric, or any combination of such interconnects. Each of the clients 101 may include, for example, a personal computer (PC), server computer, a workstation, handheld computing/communication device or tablet, and/or the like. FIG. 1 shows three clients 101a-c, but the scope of embodiments can include any appropriate number of clients.

One or more of clients 101 may act as a management station in some embodiments. Such client may include management application software that is used by a network administrator to configure storage server 102, to provision storage in persistent storage 104, and to perform other management functions related to the storage network, such as scheduling backups, setting user access rights, and the like.

The storage server 102 manages the storage of data in the persistent storage subsystem 104. The storage server 102 handles read and write requests from the clients 101, where the requests are directed to data stored in, or to be stored in, persistent storage subsystem 104. Persistent storage subsystem 104 is not limited to any particular storage technology and can use any storage technology now known or later developed. For example, persistent storage subsystem 104 has a number of nonvolatile mass storage devices (not shown), which may include conventional magnetic or optical disks or tape drives; non-volatile solid-state memory, such as flash memory; or any combination thereof. In one particular example, the persistent storage subsystem 104 may include one or more RAIDs.

The storage server 102 may allow data access according to any appropriate protocol or storage environment configuration. In one example, storage server 102 provides file-level data access services to clients 101, as is conventionally performed in a NAS environment. In another example, storage server 102 provides block-level data access services, as is conventionally performed in a SAN environment. In yet another example, storage server 102 provides both file-level and block-level data access services to clients 101.

In some examples, storage server 102 has a distributed architecture. For instance, the storage server 102 in some embodiments may be designed as a physically separate network module (e.g., an “N-blade”) and data module (e.g., a “D-blade”), which communicate with each other over a physical interconnect. The storage operating system runs on server 102 and provides a snapshot tool 290, which creates snapshots, as described in more detail below.

System 100 is shown as an example only. Other types of hardware and software configurations may be adapted for use according to the features described herein.

FIG. 2 is an illustration of an exemplary file system 200 and an exemplary snapshot tool 290 implemented by the storage operating system of system 100 and adapted according to one embodiment. In this example, a file system includes a way to organize data to be stored and/or retrieved, and file system 200 is one example. The storage operating system carries out the operations of a storage system (e.g., system 100 of FIG. 1) to save and/or retrieve data within file system 200. Snapshot tool 290 in this example includes an application executed by a processor to create a sparse snapshot 291 from file system 200. File system 200 includes the current file system arrived at with the most recent consistency point. In this example embodiment, the file system 200 includes the active file system (AFS) and snapshots 51 and S2 in the hierarchy of fs info 210-212, inodes 215-217, indirect data storage blocks (described below), and lower level data storage blocks (also described below).

At the top level of file system 200 is vol info 205, which in this example, is written in place (e.g., overwritten to a location where existing data resides), despite the fact that file system 200 is a copy-in-place file system. Volinfo 205 is a base node in the buffer tree that has a pointer to the fs info 210 of the AFS, a pointer to the fs info 211 of the snapshot 51, and a pointer to the fs info 212 of the snapshot S2. At the next consistency point, the AFS will become a snapshot and a new AFS will be created as data diverges. Thus, S1 indicates the snapshot at the immediately preceding consistency point, and S2 indicates the snapshot at the consistency point before that. The AFS will diverge from snapshot S1 as time goes by until the next consistency point. To illustrate divergence, inode files 251-257 are in the same hierarchical level. Inode files 253 and 254 are pointed to by the AFS as well as snapshot S1 and thus the data described by inode files 253 and 254 have not changed since the last consistency point. On the other hand, inode files 251 and 252 describe new data and are not pointed to by snapshot S1. The hierarchical trees for the AFS are similar to the trees for the snapshots S1, S2 (except that the tree for the AFS may change). Therefore, the following example will focus on the AFS, and it is understood that similar files in snapshots S1, S2 convey similar information.

In this example volinfo 205 includes data about the volume including the size of the volume, volume level options, language, etc.

Fs info 210 includes pointers to inode file 215. Inode 215 includes data structures with information about files in Unix and other file systems. Each file has an inode and is identified by an inode number (i-number) in the file system where it resides. Inodes provide important information on files such as user and group ownership, access inode (read, write, execute permissions) and type. An inode points to the file blocks or indirect blocks of the file it represents. Inode file 215 describes which blocks are used by each file, including metafiles. The inode file 215 is described by the fs info block 210, which acts a special root inode for the AFS. Fs info 210 captures the states used for snapshots, such as the locations of files and directories in the file system.

File system 200 is arranged hierarchically, with vol info 205 on the top level of the hierarchy, fs info blocks 210-212 right below vol info 205, and inode files 215-217 below fs info blocks 210-212, respectively. The hierarchy includes further components at lower levels. At the lowest level, referred to herein as L0, are data blocks 235, which include user data as well as some lower-level metadata. Between inode file 215 and data blocks 235, there may be one or more levels of indirect storage blocks 230. Thus, while FIG. 2 shows only a single level of indirect storage blocks 230, it is understood that a given embodiment may include more than one hierarchical level of indirect storage blocks, which by virtue of pointers eventually lead to data blocks 235.

The AFS also includes active map 226. In this example, active map 226 is a file that includes a bitmap associated with the vacancy of blocks of the active file system. In other words, active map 226 indicates which of the data storage blocks are used (or not used) by the AFS. For instance, a particular position in the active map 226 may correspond to a data storage block, and a 1 or a 0 in the position may indicate whether the data storage block is used by the AFS.

A data storage block includes a specific allocation area on persistent storage 104. In one specific example, the allocation area may be a collection of sectors, such as 8 sectors or 4,096 bytes, commonly called 4-KB on a hard disk, though the scope of embodiments is not limited thereto. A file block includes a standard size block of data including some or all of the data in a file. In this example embodiment, the file block is the same size as a data storage block. The active map 226 provides an indication of which of the data storage blocks are used by a file block of the AFS.

Additionally, AFS includes block type map 228. Block type map 228 provides an indication as to the type of data in a data storage block.

File system 200 also includes previous snapshots S1 and S2. However, as explained above, a snapshot is very similar to the AFS. In fact, a snapshot has its own fs info file (e.g., files 211, 212) and a bit map (not shown), which at one time was an active map but is now referred to as a snapmap. Thus, the snapmap is a file including a bitmap associated with the vacancy of blocks of a snapshot. The active map 226 diverges from a snapmap over time as the blocks used by the active file system change at each consistency point.

Summary map 227 is a bitmap that is derived by applying an inclusive OR (IOR) operation to the bitmaps of the various snapmaps. Summary map 227 provides a summary about the data storage blocks that are used (or not used) by any of the previous snapshots S1 and S2.

Active map 226 represents the current state of the file system 200, as new data is stored in memory (not shown) in an NV log. At the next consistency point, though, the AFS will be saved as a snapshot in persistent memory 104 (FIG. 1) and be replaced by a new active file system.

At the new consistency point, the data that is new and stored in the NV log in memory is stored in new locations in the persistent storage 104 by a write allocator process (a process provided by the storage operating system, not shown). When creating a snapshot as part of this new consistency point, snapshot tool 290 saves the fs info 215 of the current AFS into an array in the volinfo 205 and thus creates a snapshot copy. The snapshot tool 290 then updates the new summary map in the new active file system to include the blocks allocated by the snapmap (aka active map 226) of the newly created snapshot. Also, snapshot tool 290 changes any pointers affected by saving the new data and/or adds new pointers to properly reflect the state of the file system 200 at this latest consistency point.

A new fs info block (not shown) is then created, and the pointer from vol info 205 to fs info 210 is replaced by a pointer to the new fs info block. What used to be the AFS is now a snapshot 291, replaced by a new active file system (not shown). The process repeats as often as desired to create subsequent snapshots.

In a conventional snapshot creation process, the previous snapshots S1, S2 refer to some data that is of an older version. The summary map 228 marks the data blocks that have the old data as “in use” so that the old versions of the data are protected. Metadata describing that old data is protected as well. Thus, as a new version of data is created, the overall storage cost of the system increases.

However, in many instances it may not be necessary to keep all of the old data. For instance, some processes create snapshots not for long term version storage, but instead for providing a comparison with a previous version so that a difference can be calculated and sent to a data destination (e.g., for data mirroring). Thus, the presently described embodiment provides functionality in snapshot tool 290 to make the snapshot 291a sparse snapshot. For instance, snapshot tool 290 may be configured to remove as much user data and metadata as possible, leaving only the minimum amount of data or metadata sufficient to perform a desired function.

Snapshot tool 290 selectively omits data and metadata from the snapshot 291 during creation of snapshot 291 by traversing block type map 228. It is assumed in this example that a human user or a running application has directed snapshot tool 290 to remove certain types of data. With this goal, snapshot tool 290 traverses block type map 228, and where block type map 228 indicates that unwanted data is stored, snapshot tool 290 marks the summary map 227 to indicate that those data blocks are not in use. Snapshot tool 290 may not directly erase the data, but subsequent operation of the file system will eventually overwrite those unwanted file blocks in the indicated data storage blocks. Thus, the unwanted data is not “trapped” in the snapshot.

The amount and type of data omitted from a snapshot depends on the purpose for which the snapshot is created. For instance, in a physical replication, where a block-to-block copy of the volume is created at a destination, less metadata may be used by the replication application. Therefore, sparse snapshots may omit a relatively large amount of the metadata, as well as old user data. In a logical replication system, the replication application may use more of the metadata so that it can recreate a logically similar (though physically different) memory structure at a destination. In such an example, the snapshot tool 290 may create a sparse snapshot that omits old user data and omits some metadata but may omit less metadata than in the physical replication example above.

Table 1 provides an example of data that is included in some sparse snapshots, where a “yes” indicates that the particular data is included, and a blank indicates that the data is not included. Table 1 is divided into a logical replication column and a physical replication column. The block level column indicates a place in the hierarchy of FIG. 2 where the data or metadata resides—the number 0 refers to L0.

TABLE 1

| | | Physical | Logical |
|---|---|---|---|
| Data Type | Block level | replication | replication |
| regular | =0 | | |
| regular | >0 | | Yes |
| directory | =0 | | Yes |
| directory | >0 | | Yes |
| stream | =0 | | |
| stream | >0 | | Yes |
| streamdir | =0 | | Yes |
| streamdir | >0 | | Yes |
| xinode | =0 | | |
| xinode | >0 | | Yes |
| Fsinfo | >=0 | Yes | Yes |
| Volinfo | >=0 | Yes | Yes |
| Active map | >=0 | Yes | |
| Data type table | >=0 | Yes | Yes |
| Summary map | >=0 | | |
| Spacemap | >=0 | | |
| Public inofile | >=0 | | Yes |

In some instances, where an administrator has an option to perform one of several different types of a data replication (e.g., data mirroring, backup, vaulting), the selection of a data replication technique automatically causes the snapshot tool 290 to selectively omit appropriate data and metadata. For instance, the snapshot tool 290 may be programmed with different settings that correspond to different data replication techniques. Thus, a table similar to Table 1 may be programmed into the system to affect the operation of snapshot tool 290.

In Table 1, the different entries in the left-most column are as follows. “Regular” refers to user data. User data at L0 is old user data and is omitted in the examples above. “Directory” is directory data—e.g., namespaces, folders, and the like. “Stream” refers to user-tagged metadata for a file (e.g., file information from an originating operating system). “Streamdir” refers to directories for the stream data and is similar to the directory data mentioned above. “Xinode” is a type of access control list. Fs info and vol info are explained above with respect to FIG. 2. “Active map” refers to the active map; “Data type table” refers to the data type table, and “Summary map” refers to the summary map, all described above. “Spacemap” refers to another type of bitmap data that summarizes the active map. “Public inofile” is a file in which the public inodes are stored—fs info points to this file (shown as 215 in FIG. 2). In this example, “public” refers to data created by a user of the storage system, as contrasted with “private,” which refers to data created by the storage operating system for use by the storage operating system. Examples of private data include Volinfo and Fsinfo.

As shown in Table 1, for some physical replication operations, the amount of metadata carried over is small. Fs info, vol info, the active map, and the data type table can be used to create the block-to-block physical replication. When a comparing process compares a newly created sparse snapshot to a base (sparse) snapshot, such metadata provides enough information for the comparing process to discern which data blocks have changed and where those new data blocks should be stored at the destination.

Some logical replications use more metadata to facilitate the comparing process. For instance, xinode data and user data at a level above L0 may be used to recreate the information from indirect nodes. Directory and stream directory data at all levels may be useful to recreate folder and namespace information. Further, the public inode file (e.g., 215 in FIG. 2) may be used to recreate information about the hierarchical structure as a whole. Given this metadata and user data, the comparing process can discern how the hierarchical structure has changed and can send over enough of the new data to allow the destination to recreate the hierarchical structure logically. In other words, this example logical data replication saves as much pointer data as needed to facilitate a logical recreation of the structure at the destination. However, it is also noted that neither the physical replication nor the logical replication save L0 user data because L0 user data is old user data, whereas the comparing and sending process is concerned with identifying and sending the newest data and metadata to the destination.

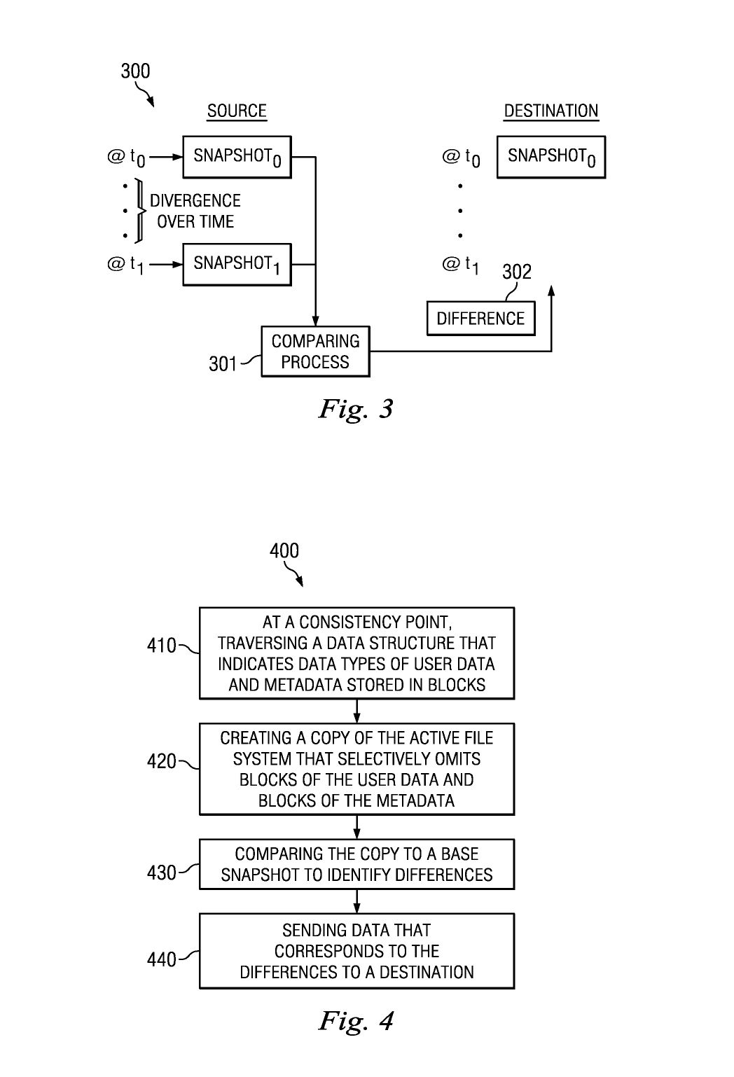

FIG. 3 is an illustration of an example data replication process 300 adapted according to one embodiment. The process of FIG. 3 may be performed by, e.g., snapshot tool 290 of FIGS. 1 and 2 to perform data backup or data mirroring. For the purposes of this example, it is assumed that the state of the volume being reproduced is the same at the source and the destination at time t0.

At time t0, a snapshot tool (e.g., tool 290 of FIG. 2) creates snapshot0 to save the state of the volume at time t0. Snapshot0 will become the base snapshot in this example. Snapshot0 is then transferred over to the destination. As time progresses, the active file system diverges from snapshot0 due to changes made to the volume. At time t1, the snapshot tool creates snapshot1 to save the state of the volume at time t1. Comparing process 301 then compares snapshot0 and snapshot1 to discern how the volume has changed since time t0. Comparing process 301 may use any appropriate technique to discern how the volume has changed, where such techniques may include walking the buftrees of the respective snapshots, walking the snapmaps of the respective snapshots, and the like. The comparing process 301 sends the differences 302 (e.g., the new data) to the destination, and the destination uses the differences 302 to recreate the volume at time t1.

As noted above, snapshot0 and snapshot1 may both be sparse snapshots with the minimum amount of data sufficient for the comparing process 301 to identify differences 302 and to send those differences to the destination. Examples of data that may be kept or omitted are given above in Table 1.

FIG. 4 is an illustration of an example process 400 for replicating data using a sparse snapshot according to one embodiment. Process 400 may be performed, e.g., by server 102 of FIG. 1 (which implements the storage operating system) when performing the actions described above with respect to FIG. 3.

The process of creating a snapshot begins at action 410, where there is a consistency point. A snapshot tool (e.g., tool 290 of FIGS. 1 and 2) traverses a data structure that indicates data types of user data and metadata stored in blocks. For instance, the example of FIG. 2 includes a block type map 228 that indicates a data type for each data storage block. The snapshot tool can traverse a block type map to discern a type of data for each block.

In action 420, the snapshot tool creates a copy or snapshot of the active file system. In creating the copy, the snapshot tool selectively omits some blocks of user data and some blocks of metadata. Action 420 is facilitated by action 410, so that in action 420 some blocks are selectively omitted based on a data type. As explained above, one example technique for selectively omitting blocks is to mark corresponding data storage blocks as unused in a bitmap or other data structure. The unwanted blocks are then unprotected and may be overwritten in the future. In action 420, the user data blocks and metadata blocks may be kept or omitted based on a purpose or intended use for the copy. In one example, only enough user data and metadata is trapped in the copy as is needed to facilitate a physical or logical replication operation. Examples of type of data that may be kept or omitted are shown in Table 1.

In action 430, a comparing process compares the copy created in action 420 to a base snapshot to identify differences. The comparing process may include comparing root nodes (e.g., fs info nodes) of the copy and the base snapshot to identify differences, although any suitable comparison technique may be used.

In action 440, the data source sends data corresponding to the differences to a destination. For instance, the data corresponding to the differences may include data or metadata that has been added or modified since the base snapshot was taken. In this manner, the data destination may recreate the active file system using periodically-received updates from the source.

The scope of embodiments is not limited to the exact procedure shown in FIG. 4. For instance, some actions may be added, omitted, rearranged, or modified. In one example, the process 400 is repeated at subsequent consistency points to send subsequent data updates to the destination. In another example, a tool (e.g., snapshot tool 290) may modify snapshots that have already been created. In this example, the snapshot tool may select one or more existing snapshots and delete data and/or metadata to “sparsify” those snapshots. As described above, the data and/or metadata may be deleted by marking the corresponding storage blocks as unused in the summary map. Additionally, various embodiments may be adapted for use in any of a variety of file systems, such as encrypted file systems, compressed file systems, and the like.

Embodiments of the present disclosure can take the form of a computer program product accessible from a tangible computer-usable or computer-readable medium providing program code for use by or in connection with a computer or any instruction execution system. For the purposes of this description, a tangible computer-usable or computer-readable medium can be any apparatus that can store the program for use by or in connection with the instruction execution system, apparatus, or device. The medium can be an electronic, magnetic, optical, electromagnetic, infrared, or a semiconductor system (or apparatus or device). In some embodiments, one or more processors (not shown) running in server 102 (FIG. 1) execute code to implement the actions shown in FIGS. 3 and 4.

Because sparse snapshots may not be as comprehensive as conventional snapshots, their use by unsuspecting applications may at time be undesirable. For example if a given application tries to read an unprotected block which the write allocator has reused for other purposes, the application is likely to get a Lost-Write error. For this reason, in many embodiments, the sparse snapshots are not exposed to some clients and may not appear in some directories to avoid error. In another embodiment, a storage utility includes the ability to detect that a client is reading from the sparse unprotected regions of a sparse snapshot and fail those read requests gracefully. The same storage utility detects when the client is reading from a part of the snapshot that is not sparse and may let the same client read from the protected regions of the same sparse snapshot. However, various embodiments are not limited to these precautions, and in fact, the embodiments may use sparse snapshots in any appropriate manner.

Various embodiments may include one or more advantages over conventional systems. For instance, in some systems old user data accounts for about 98% of data storage. Storage systems using sparse snapshots to omit old user data may therefore see a significant amount of storage space freed for other uses. Furthermore, because sparse snapshots are smaller than conventional snapshots, sparse snapshots may be kept on the system longer, even if an autodelete feature is used.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method performed in a computer-based storage system, the method comprising:
creating a copy of an active file system at a first point in time, where the active file system includes user data, metadata describing a structure of the active file system and the user data, and a first data structure describing storage locations of the user data and the metadata;
in which creating a copy of the active file system includes selectively omitting a portion of the user data and a portion of the metadata from the copy.

2. The method of claim 1 in which selectively omitting comprises:
traversing a second data structure that describes for each of the storage locations, a type of data stored in a respective storage location; and
marking ones of the storage locations as unused in the first data structure based on a data type stored in each of the ones of the storage locations.

3. The method of claim 1 in which the first data structure comprises a bit map, where each bit in the bit map represents one of the storage locations.

4. The method of claim 3 in which selectively omitting comprises:
setting ones of the bits, corresponding to the portion of the user data and the portion of the metadata, indicating that respective storage locations are unprotected.

5. The method of claim 1 in which selectively omitting comprises:
comparing the copy of the file system to a base snapshot to discern differences therebetween; and
sending data corresponding to the differences to a replication destination.

6. The method of claim 1 in which selectively omitting comprises:
omitting a portion of the metadata to leave only a minimum amount of the metadata sufficient to compare the copy to a base snapshot and to discern new data for a data replication operation.

7. The method of claim 6 in which the data replication operation comprises a physical replication, and wherein the portion of the metadata omitted from the copy includes directory and inode data.

8. The method of claim 6 in which the data replication comprises a logical replication, and wherein the portion of the metadata omitted from the copy includes stream and access data for old user data.

9. The method of claim 1 further comprising:
preventing exposure of unprotected areas of the copy to one or more clients to prevent access errors while allowing access to protected areas of the copy.

10. A network-based storage system comprising a memory and at least one processor, in which the processor is configured to access instructions from the memory and perform the following operations:
creating a copy of an active file system, the copy including at least a portion of metadata in the active file system and a portion of user data in the active file system, in which creating a copy of the active file system includes: omitting blocks of the metadata and blocks of the user data from the copy based on a type of the user data and a type of the metadata in the blocks;
comparing the copy to a previous snapshot of the active file system to identify differences between the copy and the snapshot; and
sending portions of the copy that correspond to the differences to a data destination.

11. The network-based storage system of claim 10 in which the one or more processors further perform:
reading a data structure that includes type information for the user data and metadata in the blocks.

12. The network-based storage system of claim 10 in which the active file system includes modified user data and metadata describing the modified user data, further in which the modified user data has been modified after creation of the snapshot, further in which at least a portion of the metadata describing the modified user data is included in the copy.

13. The network-based storage system of claim 10 in which the data replication comprises a logical replication, and wherein the blocks of the metadata omitted from the copy include stream and access data for old user data.

14. The network-based storage system of claim 10 in which the data replication comprises a physical replication, and wherein the blocks of the metadata omitted from the copy include directory and inode data.

15. A computer program product having a computer readable medium tangibly recording computer program logic for performing data replication in a computer-based storage system, the computer program product comprising:
code to begin a snapshot creation process for an active file system at a consistency point;
code to discern data types in respective data storage blocks in the active file system;
code to create a first snapshot that omits portions of user data and portions of metadata responsive to discerning the data types; and
code to compare the first snapshot to a second snapshot to identify new data to send to a destination.

16. The computer program product of claim 15 further comprising:
code to send the new data to the destination.

17. The computer program product of claim 15 in which the code to create the first snapshot comprises:
code to mark the portions of user data and the portions of metadata as unprotected.

18. The computer program product of claim 15 in which the code to create the first snapshot comprises:
code to omit old user data from the first snapshot.

19. The computer program product of claim 15 in which the code to create the first snapshot comprises:
code to omit directory and inode data, facilitating a physical data replication at the destination.

20. The computer program product of claim 15 in which the code to create the first snapshot comprises:
code to omit old user data and to include data for recreating pointers of the active file system, facilitating a logical data replication at the destination.

21. A method performed in a computer-based storage system, the method comprising:
creating a snapshot of an active file system at a consistency point, where the active file system includes user data, metadata describing a structure of the active file system and the user data, and a first data structure describing storage locations of the user data and the metadata;
after the snapshot has been created, selectively deleting a portion of the user data and a portion of the metadata from the snapshot by marking one or more storage block as unused.
